(19) United States
(12) Patent Application Publication
(10) Pub. No.: US 2002/0186845 A1
(43) Pub. Date: Dec. 12, 2002

(54) Method and apparatus for remotely disabling and enabling access to secure transaction functions of a mobile terminal

(76) Inventors: Santanu Dutta, Cary, NC (US); Angana Ghosh, Morrisville, NC (US)

Correspondence Address: MOORE & VAN ALLEN, PLLC, 2200 W MAIN STREET, SUITE 800, DURHAM, NC, 27705, US

(21) Appl. No.: 09/878,468

(22) Filed: Jun. 11, 2001

(51) Int. Cl. H04K 1/00

(52) U.S. Cl. 380/247; 380/270

(57) ABSTRACT

Method and apparatus for remotely disabling and enabling access to secure transaction functions of a mobile terminal. A service enables a user to immediately block access to the payment and user authentication functions in the security element of a phone or other type of mobile terminal by sending a radio message, such as a wireless application protocol (WAP) push message. These functions can be turned on again with another radio message. The security element includes a memory that is encoded with keys or key pairs for authentication and/or digital signatures, and a status register or status indicator associated with each such key. The status register is settable to a first state wherein access the key is enabled and to a second state wherein access to the key is disabled. If the terminal is equipped with a GPS subsystem, the terminal can return a confirmation message containing position information.

### BACKGROUND OF THE INVENTION

With the advent of mobile e-commerce, a security element (SE) is becoming an essential component of mobile phones and other mobile terminals, hereafter referred to simply as “mobile terminals” or “wireless communication terminals”. The SE is a tamper-resistant, trusted component in a phone that contains the private and public key-pairs used for authentication and digital signature functions in secure transactions.

Based on current technology, the SE may take many forms, including removable and non-removable types, relative to the mobile terminal. A well-known removable type of security element is the subscriber identity module (SIM), currently used in telephones that operate according to the Global System for Mobile (GSM) standard. Another known removable security element is the WAP identity module (WIM) where WAP stands for wireless application protocol, an over-the-air protocol designed to carry Internet traffic so that wireless communication terminals can run Internet protocol (IP) applications and be used for Internet access. It should be noted that the WIM can also take non-removable forms. A device that has GSM telephone capability and WAP capability needs both SIM and WIM functionality, which may be provided by separate devices, or by a combination card with both functions, colloquially called a “SWIM” card. All these SE's may be implemented on smart cards, since they typically include a processor and memory.

Mobile terminals that are enabled for mobile, secure, e-commerce with SIM or WIM cards use the wireless public key infrastructure (WPKI), which is currently the most popular among security choices for mobile e-commerce. The WPKI works in a similar fashion to the PKI used in the wired Internet, with a user's key pair consisting of a public and private key. The same key pair can be used for multiple services by assigning multiple service certificates to the same key pair. Thus, many service certificates can be assigned to a small number of key pairs. Typically, two key pairs suffice: one for authentication and one for signature, also referred to as authorization. A service certificate is an electronic document signed by a trusted third party a certification agency (CA)—which states that a named entity is a certified user of the public key contained in the certificate for the service identified by the certificate number. Service certificates may be used as electronic credit cards in mobile e-commerce. However, since many “credit cards” can be assigned to a small number of key pairs, the issuer of the SE may not be the issuer of the service certificate, so that the issuer of the SE does not control all uses of the SE.

Currently, if a SIM-enabled mobile terminal is lost or stolen, a user can notify his or her wireless service provider, who can block access to the network at the wireless infrastructure. FIG. 1 illustrates this scenario. Wireless phone 101 using SIM card 102 normally accesses the wireless operator's infrastructure 103 through public land mobile network (PLMN) 104. In turn, the public switched telephone network (PSTN), 105, and the Internet, 106 can be accessed. When access to the network is denied at infrastructure 103, as indicated by the cross in the box depicting 103, the denial of service is based on the phone number of the lost phone recorded in the phone's SIM card. This system can be used to block access to secured transactions that depend on using the PLMN.

FIG. 2 shows how a lost mobile terminal is treated so that access to secured transactions is blocked even for transactions that do not go through the PLMN network operator's wireless infrastructure. One example of such transaction is that conducted over the short range radio technology, Bluetooth, in the 2.4 GHz unlicensed band. Bluetooth technology can be used to make credit card payments from a mobile phone in a physical retail store in a manner very similar to that used for making credit card payments to a remote webshop as shown in FIG. 1. In the Bluetooth payment example, wireless telephone 201 includes an SE, 202, such as a WIM or SWIM card that is encoded with a key pair for multiple certificates. The WPKI is used to access the retail merchant's transaction server, 203, using a Bluetooth radio link, 208. Bluetooth access points, 204, are located throughout the retail store and are tied together by an in-store LAN, 207, which is also connected to the merchant's transaction server. A particular Bluetooth access point, 204, is accessed by a user for making payment at check-out time. The transaction server, 203, approves or declines the payment transaction requested by the phone, based on the validity of the certificates carried by the phone. In this case, the legitimate user of the wireless phone notifies the certificate issuer, 205, of the loss. The issuer then adds its certificate to a certificate revocation list (CRL) which is sent to merchant, 203, through the regular secure payment gateway, 206, so that the merchants know to deny transactions attempted using the phone. This process is analogous to notifying all your credit card companies that your wallet has been lost. This scenario blocks transactions that do not use the PLMN, but can take time. Some certificate issuers only transmit CRL's every few days, or once a week. It is noteworthy that blocking access at the PLMN network operator's infrastructure does not block usage of the phone for payments and other secure transactions conducted over Bluetooth.

### BRIEF SUMMARY OF THE INVENTION

The present invention enables a user to immediately block access to the payment and user authentication functions in the tamper resistant security element of a phone or other type of mobile terminal with a radio message. The radio message, which is sent through a pre-arranged service provider, can be sent easily, by a variety of means, in an emergency. The receipt and recognition of this message by the terminal blocks payment and user authentication functions in the terminal. When and if the phone is found, these functions can be turned on again by the user with another radio message, thereby re-enabling payment and authentication from the phone. The cancellation of individual service certificates, carried in the phone in electronic form, may be performed later if the user so desires. In one embodiment, the phone can notify a user of its location when it receives a disablement radio message from the provider of the disablement service.

In one embodiment of the invention, a service is provided for remotely controlling a security element of a mobile terminal for disabling access to secured functions, such as e-commerce transactions. When a user wishes to remotely disable the e-commerce capability of his or her terminal, he or she accesses the service via the telephone network, the World Wide Web, Email, or other means. A server or servers owned by the service provider verifies authenticity of the user, and creates a signed message including, at least, an address for the mobile terminal and instructions for disabling the mobile terminal. The instructions may consist of content that causes a disablement application to be executed. The service provider then sends the message to the mobile terminal. The mobile terminal can respond with an authenticated confirmation message. The disablement service provider can then respond to the user indicating the outcome of the attempt, or, after a specified time period, indicate no response. A user can re-enable access to disabled functions with another request that generates another message.

In one embodiment, the message includes content that causes either the disablement, or the re-enablement, as the case may be, to be performed. This content can be the identification of a disablement application within the mobile terminal to be executed to carry out the disablement or enablement. Alternatively, the content can be a URL for a calling program that resides on a server that in turn activates an application to perform the disablement and/or enablement. In one embodiment, a push initiator embodied in a server or similar type of general-purpose computer system operates by executing a computer program product to implement portions of the invention. The push initiator is connected via a network, such as the Internet, to a push proxy gateway operable to receive the signed push messages and send over-the-air messages to the mobile terminal. A wireless service provider may operate the push proxy gateway. This hardware and appropriate computer program code form the means for carrying out the service of the invention by the service provider.

Mobile terminals must understand the messaging involved in order to implement the invention. In one embodiment, a push message to disable the mobile terminal disables the security element entirely. However, if the push message only disables access to the specific security key pairs, the mobile terminal is able to send back a confirmation message, secured with a key pair that is specifically dedicated to this purpose. A mobile terminal such as a mobile phone according to the invention typically includes a radio block, the security element encoded with at least one key pair for providing user authentication services, and a processor system operably connected to the radio block and the security element. Supporting logic is usually also needed. The processor system is operable to disable and enable access to the key pair in response to the unsolicited, over-the-air, push messages received through the radio block. By unsolicited, we mean that the push message was not initiated by signaling from the mobile terminal. The processor system includes program code or “microcode” that enables its operation, including, in one embodiment, the application to disable and re-enable access to the security element functions. This or similar hardware in the mobile terminal together with appropriate microcode is the means for carrying out the invention at the terminal.

A security element in one embodiment of the invention can be embodied as a smart card, which includes a processor of its own, and memory. The memory contains a data structure for providing user authentication services. The data structure includes at least one key pair for providing the user authentication and authorization services for transactions initiated by a user of the mobile terminal, and a status enabled/disabled indicator associated with each such key pair. The status indicator is settable by the mobile terminal to a first state wherein access to the key pair is disabled and to a second state wherein access to the key pair is enabled. In one embodiment, the status indicator is a status register within the security element. Accommodating the status register inside the tamper resistant security element ensures that a fraudulent user, in possession of a lost or stolen phone, cannot alter the status of the status register. Note that key pairs used for user authentication and authorization are distinct from any key pair that might also be included to authenticate the confirmation messages according to the invention.

### BRIEF DESCRIPTION OF THE DRAWINGS

FIG. 1 illustrates one way a lost or stolen mobile terminal, such as a phone, is disabled in the prior art.

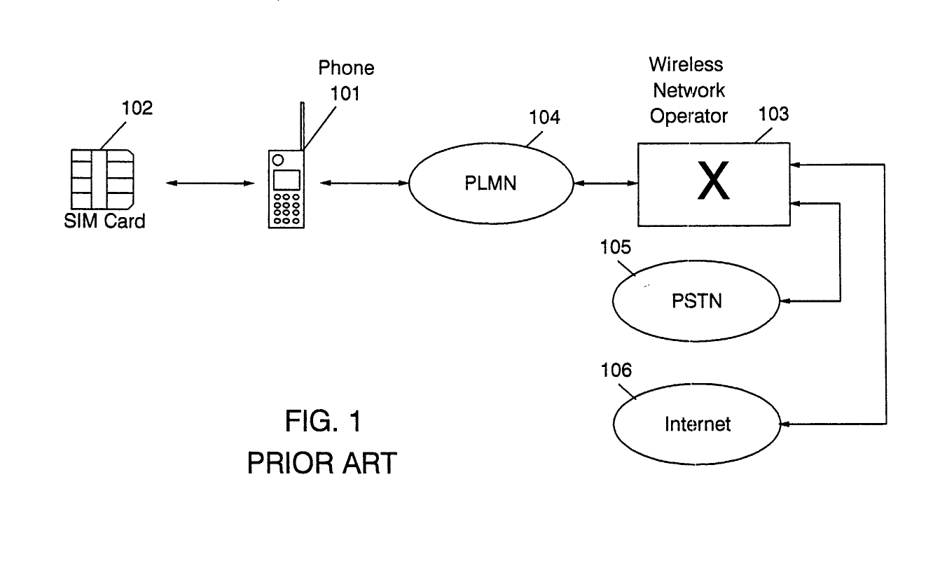

FIG. 2 illustrates one way in which the ability to conduct secured transactions from a lost or stolen mobile terminal, such as a phone, is disabled in the prior art.

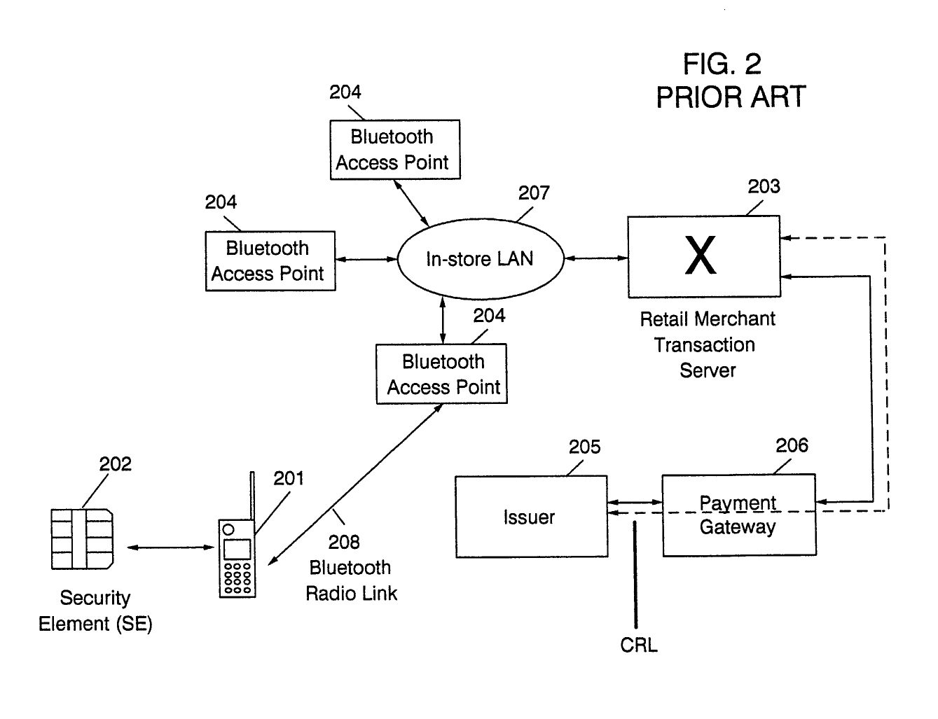

FIG. 3 is a system block diagram that illustrates the how the various components of the network and the mobile terminal interact according to one embodiment of the invention.

FIG. 4 is a network diagram illustrating how push messages are transmitted from a service provider according to one embodiment of the invention to a mobile terminal.

FIG. 5 is a message flow diagram that illustrates the sequence of messages when certain messaging according to one embodiment of the invention takes place.

FIG. 6 is a message flow diagram that further illustrates the sequence of messages when certain messaging according to one embodiment of the invention takes place.

FIG. 7 is a block diagram of a programmable computer system that carries out some functions of the invention in one embodiment.

FIG. 8 is a block diagram of a mobile terminal that carries out some functions of the invention in one embodiment.

FIG. 9 is a block diagram of a smart card implementation of a security element that carries out some functions of the invention in one embodiment.

### DETAILED DESCRIPTION OF THE INVENTION

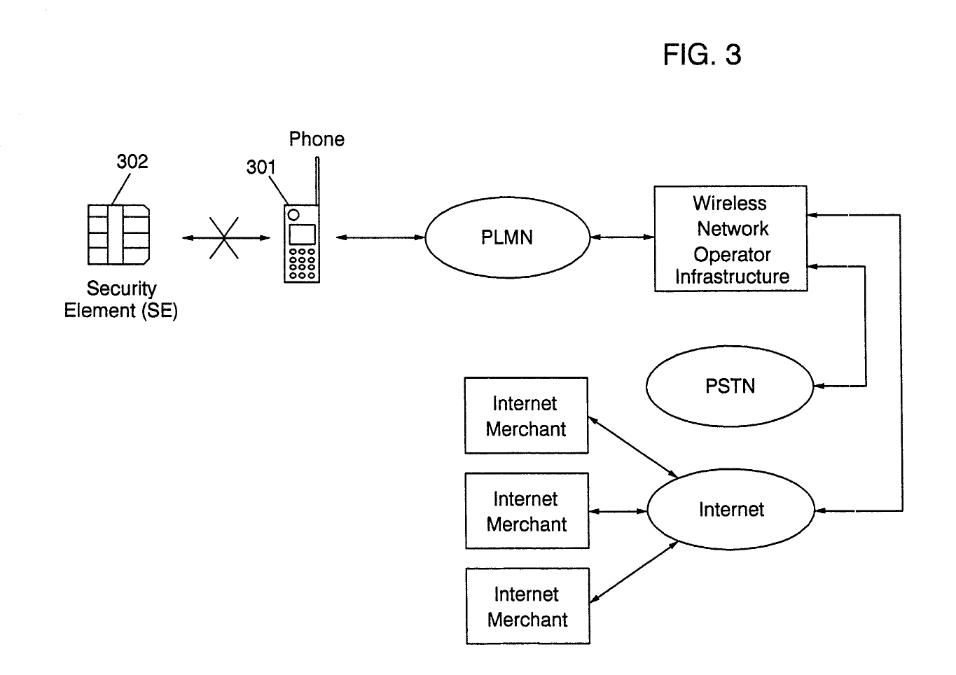

FIG. 3 is a block diagram that illustrates the operation of the invention at a high level. No blocking or disabling actions need be carried out in the PLMN, the wireless network operator infrastructure, the PSTN, the Internet, or by the merchants. Instead, access from the mobile terminal, in this embodiment phone 301, to the SE 302 is selectively blocked for certain functions, such as signature and authentication, which carry a high security risk. As users often find their terminals after a period of temporary loss, it is also desirable to provide for secure remote enabling (or re-enabling) of the SE.

In another embodiment of the invention, access to the entire SE is blocked by a wireless command message. If implemented according to the WAP/WIM specifications, this would correspond to blocking access to one of the user's personal identification numbers known as PIN-G, which is stored in the security element and is compared to the user-entered version of the same PIN. Access to functions in the security element is allowed only if the PIN-G entered by the user matches the stored version. According to this invention, the stored version of PIN-G would be made inaccessible by the security element. In a wallet analogy, this complete block would correspond to sealing the entire wallet by remote control, whereas the selective block described above would correspond to sealing only the credit card compartment. While this complete disabling of access is a feasible solution, it has a significant disadvantage in that it precludes the phone sending a signed confirmation message, when the signature key for the confirmation message is in the same security element. Such a confirmation message confirms that the disablement actually occurred, and, in one embodiment, can also provide location information for the mobile terminal, which might aid in recovering the phone. Signing of the confirmation message is performed with a key separate from the ones used for user authentication and secure-transaction authorizations. The confirmation message signature key would typically be resident in the sealed SE. If signed confirmation messages are desirable, it is necessary to keep the SE open for functions other than the authentication and authorization functions used in secure transactions, such as financial transactions.

The SE may take the form of a removable or non-removable SIM or WIM smart card. A technical specification standard for a SIM card is published by the European Telecommunication Standards Institute (ETSI), and is entitled “Digital Cellular Telecommunications System (Phase 2+); Specification of the Subscriber Identity Module—Mobile Equipment) (SIM-ME) Interface (GSM 11.11),” Version 5.0.0, December, 1995, and is incorporated herein by reference. A technical standard for a WIM card is published by the Wireless Application Forum, Ltd., and is entitled, “Wireless Application Protocol Identity Module Specification,” Document number WAP-198-WIM, the most recent version of which is dated Feb. 18, 2000 and is incorporated herein by reference. At various places throughout this disclosure the terms “authentication and authorization services”, “authentication and digital signature” and the like are used in reference to a security key or key pair. Such usage is meant to generically refer to either authentication and signature/authorization together or one of the two by itself.

In one embodiment, an Internet-based service, which we refer to as a Remote SE Access Control Service (RSE-ACS) is available to send unsolicited, “push” command messages to the lost mobile terminal. The term unsolicited in this context refers to the fact that no signaling from the mobile terminal is needed to initiate the push command message from the service. The user solicits the push messages, in a general sense, by signing up for and using the service. This service can be provided by any of a number of entities, including network operators, financial institutions (typically issuers of service certificates), and insurance companies. It may be a service that is offered free or for charge or based on a subscription fee, per usage charge, or some combination thereof. The service can be set up so that users pre-register, or access and start the service for the first time when a phone or other device is lost, or so that users can do either.

The push messages may be sent by a variety of wireless protocols, including open standard protocols such as GSM short message service (SMS) and WAP push, as well as proprietary protocols. By way of example only, a WAP push implementation is described herein. WAP push messages are described in well-known standard specifications published by the Wireless Application Protocol Forum including, “Wireless Application Protocol Push Message Specification,” published Aug. 16, 1999, the most recent version of which is incorporated herein by reference. It should be noted that the practice of the invention is not limited to WAP and that the invention is wireless protocol independent.

As a part of the user registration process for RSE-ACS, a user verification process is established. The user verification should be simple yet reliable, and can include any of a multiplicity of optional verification techniques. As an example, such user verification can consist of requiring the user to produce some private and secret data, including but not limited to a username, password, address, mother's maiden name and a personal identification number, or PIN. In may be advantageous to use information other than or in addition to a PIN to screen the user for access to the RSE-ACS, since the service will not be used frequently, making a PIN difficult to remember. One option is to use other information to access the service, and the PIN to actually send the push message. In this case, the PIN can be recorded and stored in a safe place with relatively minimal risk. The PIN can also be longer than the 4-6 digits used for user verification in typical secure mobile services. As an alternative to PIN, biometrics can be used for user verification. In biometrics, the user is identified to the phone by verifying some personal physical characteristic, such as his/her fingerprint.

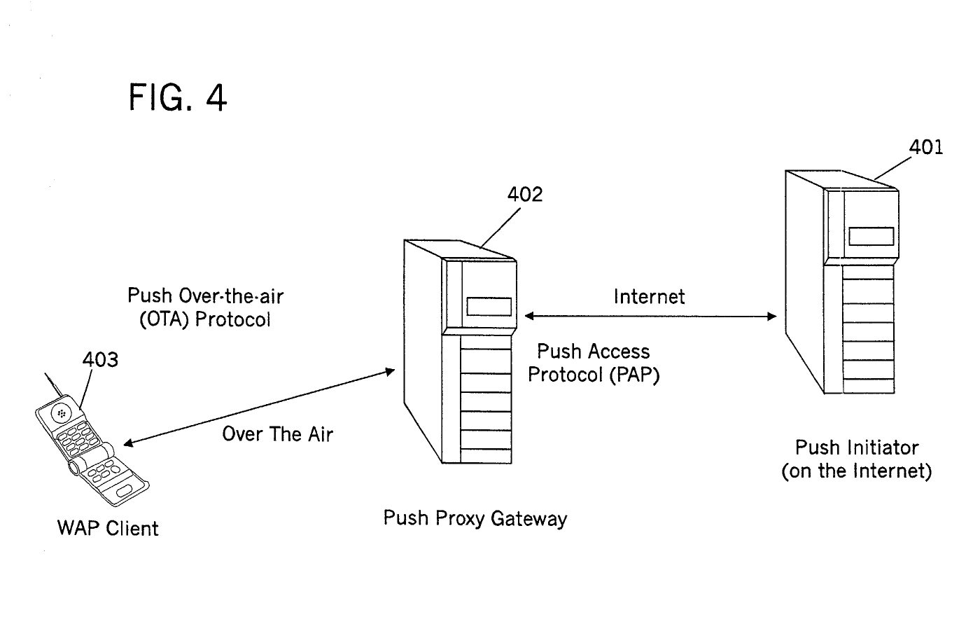

On successful user verification, the RSE-ACS, which is the push initiator (PI), sends a request to a push proxy gateway (PPG) to issue a push message to the lost mobile terminal, by way of example, a wireless phone. The network topology involved is illustrated in FIG. 4. In FIG. 4, push initiator 401 sends a push message to PPG 402. Although the Internet is shown as the connection between the PI and PPG, it is possible to have other types of networks connecting these two entities, including a dedicated point-to-point link or a private local area network (LAN). The latter would be applicable when the PPG and the PI are co-located, as might be the case if they are owned by the same entity. The push message is signed at the application level by a private key belonging to the RSE-ACS, thereby proving to the phone that the message is not originating from a fraudulent source attempting a denial of service attack.

The Internet-side PPG access protocol is called the Push Access Protocol (PAP) and the wireless-side (WAP) protocol is called Push Over-the-Air (OTA) protocol. PAP uses extended markup language (XML) messages that may be tunneled through various well-known Internet protocols like hypertext transfer protocol (HTTP). The OTA protocol is based on wireless session protocol (WSP) services. In FIG. 4, the push message that originates at the P1 is converted to an OTA protocol message by the push proxy gateway, and is finally transmitted to lost terminal 403. A push message contains headers and a body. When the PPG receives the push message, it examines the message and performs any required coding and transformation needed by OTA or WSP services. The PPG does not remove any headers, although it may add additional headers. Most WAP push headers are based on HTTP headers, although there are some WAP specific headers. One WAP specific header, which is useful to implement one embodiment of the invention is an application identifier header, called X-Wap-Application-Id in the WAP push message specification. The push message content is further discussed in reference to the signal flow diagrams below.

In addition to the push message being authenticated by the digital signature of the RSE-ACS, it is also necessary that only the correct mobile terminal act upon the message. To ensure the message is terminal specific, it is labeled with the phone number or other address of the mobile terminal. The push message may be sent as a connectionless push message using a one-way bearer service. For example, SMS as supported in most PLMN's, including GSM, could be used, resulting in the push messages being sent on WAP-over-SMS. Alternatively, the push message may be sent on a two-way bearer service, using what is known in the WAP standards as connection-oriented push. Connection oriented push requires a WAP over circuit-switched data (CSD) or WAP over general packet radio service (GPRS) connection. Regardless of the mode of message transport, in the case of a wireless phone, labeling the message with the targeted terminal's phone number, also referred to as mobile subscriber ISDN number (MSISDN), is sufficient to ensure the delivery of the message exclusively.

An advantage of the connection-oriented mode is that the mobile terminal can provide confirmation of receipt to the PPG. However, in WAP, sending a connection-oriented push requires that an active WSP session be available, as such a session cannot be created by the PPG. To solve this problem, WAP allows for a session initiation application in the client which listens to session requests from PPG servers and, optionally, after verifying the identity of the server, responds by setting up a WSP session. An advantage of connectionless push delivered over an SMS bearer is that it can reach a terminal with greater probability (in inferior propagation conditions) than the connection-oriented push delivered over regular circuit or packet switched bearer services, since an SMS signal can tolerate more attenuation.

The wireless terminal according to one embodiment of the invention is configured so that push messages, originating from the RSE-ACS are verified as such by the terminal through a digital signature applied to the push message content. Such messages are given high priority at the terminal and cannot be blocked by any means, except by turning off power or blocking signal propagation. It should be noted that these characteristics do not apply to all push messages, as normally, the user may configure his or her terminal to block push messages from some or all sources. According to this embodiment of the invention, if the terminal is turned on and a signal of sufficient strength and quality is available, the push message will get through to the terminal and perform its assigned task. A user cannot configure the terminal to ignore or block the push messages of the invention except by tampering with the native microcode in the terminal. Such code tampering is sufficiently difficult, especially in a limited time window, that the SE disabling technique described in this disclosure provides substantial value to most users.

Although a non-maskable push message is recommended in this invention to maximize security, it does not preclude implementations where the user is given the choice, after user verification by a PIN or other means, to selectively mask the push message, thereby disabling the service described here.

The RSE-ACS of the invention will make several attempts over a predetermined period of time, with a predetermined waiting period between each attempt, to deliver the message. The retries increase the probability of reaching a terminal that is temporarily turned off or otherwise blocked from service. The specific algorithm used to retry message delivery will depend on the RSE-ACS service provider, who may offer a menu of retry algorithms, possibly at different price levels. A particular opportunity for a RSE-ACS service provider who is also the PLMN network operator is to cue the push messages on the mobile terminal being logged on to the PLMN network—this will avoid the sending of push messages to phones that are turned off or blocked from a propagation viewpoint. A RSE-ACS service provider who is not a PLMN network operator will not normally have access to the logged-on status of the mobile terminal relative to the PLMN; however, this information may be obtained from the PLMN network operator through a business arrangement.

The receipt of the push message will either disable or re-enable status registers contained in the SE, each register corresponding to an authentication or authorization (signature) key pair in the same SE. According to the invention, the registers must be checked whenever an authentication or authorization key pair is accessed by any application in the terminal. The terminal may, in addition to checking these registers, require a correct user PIN entry for access to the authorization key pair as a user selectable option, as is currently the case according to the standard WIM specification previously discussed. This embodiment of the invention provides that the status register for a key or key pair must be set to a first state representing an enabled status in order for the key or key pair to be accessed. If the status register is set to a second state representing a disabled status, access is blocked. The SE interface according to the invention further includes a command set for setting the registers to their enabled and disabled key pair access states. The command set includes, in this example, two commands:

enable_keypair_x; and

disable_keypair_x

where “x” refers to the specific key pair.

According to one embodiment, on successful execution of the disablement or re-enablement function in the mobile terminal, the terminal sends service confirmation messages directly to the RSE-ACS. The disablement confirmation message is digitally signed while the re-enablement message is unsigned. In order to receive these messages, the RSE-ACS should be equipped with or have access to, an adequate mobile Internet infrastructure. Where the wireless protocol is WAP, a WAP gateway is hosted by the RSE-ACS itself or a WAP service is provided through a gateway hosted by a third party.

Throughout this disclosure, we refer to an application that disables and/or enables access to the secured functions as a “disablement application” for convenience. We also use the terms “enable, enablement, etc.” and the terms “re-enable, re-enablement, etc.” interchangeably. Note that the disablement application can be as simple or complex as deemed necessary to carry out a particular embodiment of the service. The application may simply be microcode within the phone that directly executes the disablement or re-enablement.

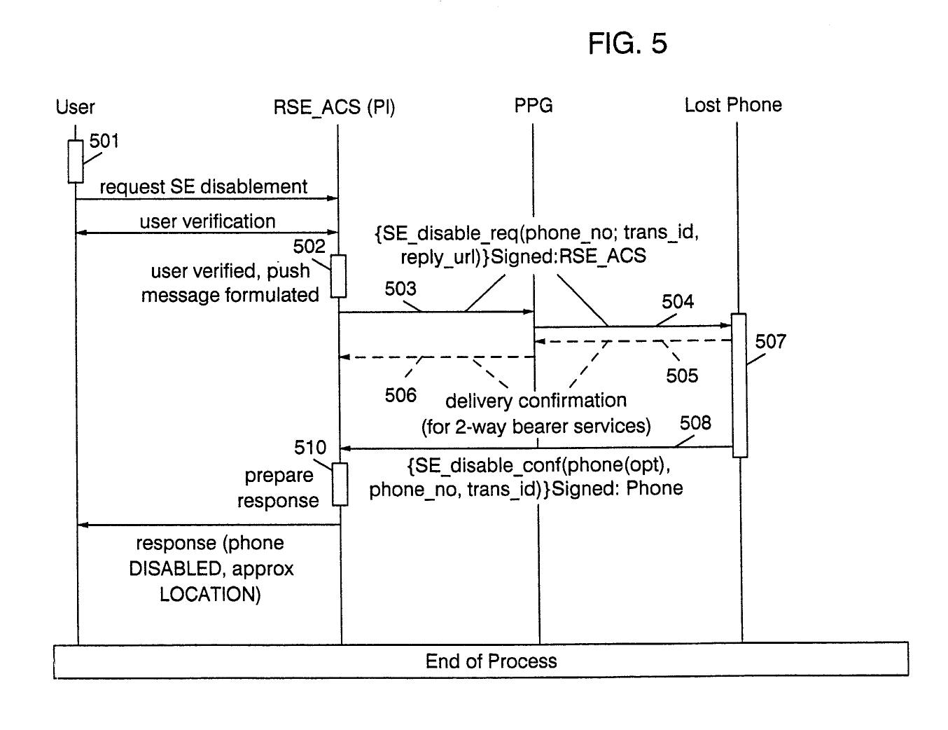

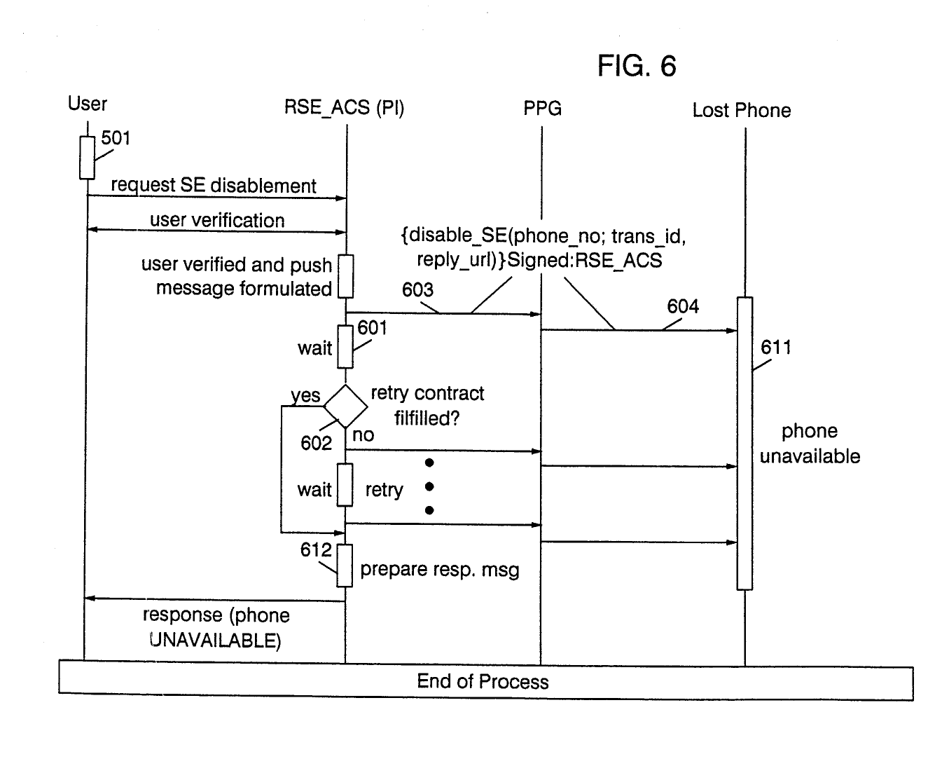

The message flow diagram of FIGS. 5 and 6 illustrate usage scenarios for the service of the invention. For example purposes, we assume the particular mobile terminal involved is a wireless phone. In one embodiment, a user access the RSE-ACS service from a personal computer or other Internet connected terminal by navigating to a World Wide Web page maintained by the party providing the service. However, in some cases, a PC may not be available to the user when the loss of the phone is realized, therefore provisions for telephone voice access to the RSE-ACS can be provided. The service may be provided by a human operator performing the user verification by querying secret data and then manually initiating the service, or by an automated voice-response service. Once the user is verified either by manual query of secret information, or by a PIN in the cases of an automated voice-response system and direct PC access, the push message is sent. As mentioned above, if the logged-on status of the phone relative to the PLMN is available, this can be used to determine when the push message is actually sent. A confirmation response message from the service to the user can be provided by voice to a call back number left by the user, by Email to an address provided by the user, or by a combination of the two.

If the user verification is successful, the service attempts to send a signed push message to the lost phone. If and when the push message gets through, the phone responds with a signed confirmation message, which includes confirmation of disablement and potentially other information. The phone position information, for example, as provided by a GPS subsystem in the phone or other means, can optionally be included to aid in phone recovery. The essence of the confirmation message, possibly reformatted, is forwarded by the RSE-ACS as a response to the user as described above. If the phone is unavailable because it is powered off or in a location where propagation is blocked, the response contains this information.

Often, a user finds a lost phone after a period of time and wishes to re-enable it. In this event, the user accesses the RSE-ACS, authenticates himself or herself through the above-described user verification procedure, and requests to send a re-enablement message. On successful user verification, the service sends a signed push message containing the re-enablement instructions. The message may optionally also contain other information to be displayed on the phone, such as a message like, “Your phone is now re-enabled,” together with RSE-ACS branding data. This serves to assure the user that the phone is now useable for secure transactions. Alternatively, this screen may be pre-stored in the phone and displayed on completion of re-enablement by an application in the phone, which is named in the re-enablement push message. On receipt of the re-enable push message, the signature and authentication key pairs in the SE are restored to enabled status. The phone sends the RSE-ACS a confirmation message. This proves to the RSE-ACS that the SE in the lost phone has indeed been re-enabled and the contracted service has been completed. The RSE-ACS then sends a completion of service confirmation response to the user in the same way as for disablement.

FIG. 5 illustrates the messaging involved in the disablement scenario where the phone is available. The push messages are sent by the PPG as object-level signed content messages, signed by the PI operated by or for the RSE-ACS. This signature obviates any need for the PPG to authenticate the P1, although such authentication may be performed as matter of policy by the PPG for all push messages. In addition, authentication of the PI is performed by the phone, thus providing end-to-end security.

In FIG. 5, a user determines that his or her phone is lost at 501, and requests SE disablement to activate the service. User verification messages are exchanged. The service verifies the user and formulates the push message at 502. The push message content will contain the following information, as indicated in FIG. 5:

reply_url: RSE-ACS uniform resource locator (URL) used by the phone to address the disablement confirmation message;

phone-no: lost phone's number (MSISDN);

trans-id: a transaction id that is used to identify the disablement session.

The push message from the Pi to the PPG is shown at 503, and from the PPG to the phone is shown at 504. A “deliver before timestamp” parameter is included in the push message control element from the PI to the PPG, but is not a part of the message delivered to the phone. This parameter should be sufficiently large to allow for reasonable delays or out of range periods, or can be agreed upon between the user and the RSE-ACS as part of a service contract. This parameter specifies the date and time by which the content must be delivered to the mobile phone; content that has aged beyond this date will not be delivered by the PPG. Regardless of the retries performed by the PPG, retries are also initiated by the P1 according to the serv10 ice contract between the user and the service provider.

If a two-way bearer service is used, the phone provides an unsigned delivery confirmation to the PPG as shown at 505. This delivery confirmation can be forwarded by the PPG to the PI for monitoring purposes at 506. Note that this is a confirmation that the message was received by the phone, and is not the same as the confirmation of disablement, discussed below.

The message has the address of the targeted lost phone, both at the application layer, for example, in the message body, and at a lower protocol layer, for example, in the message control element. The delivery priority should be set to “high” in the message control element. The message is routed through the appropriate base station so that it reaches the phone using the normal routing process for the selected bearer service. The push content is signed by the RSE-ACS's private key, proving to the phone that the message is not originating from a fraudulent source making a denial of service attack.

At 507, the phone processes the push message. The phone checks the signature on the push message. If the signature is unrecognized, the message is discarded. If the message is recognized, it is checked for content type. Message content, in this embodiment, the application ID in the WAP header, as previously discussed, will identify the application to be run by the phone. An application dispatching program resident in the phone reads the application ID in the push message and will deliver the message content to the appropriate application. On recognition of the Application ID, the phone will run the disablement application. Optionally this application will fetch the phone position. In any case, the application sets the appropriate authentication key pair and authorization key pair status fields to the disabled status.

At 508, the phone sends a signed service confirmation message, which optionally includes a position field. The confirmation message is signed by the private key of a special key pair, resident in the SE and only used for sending confirmations of remote disablement; the message is sent to the RSE-ACS URL contained in the original push message. The RSE-ACS provider provides the service certificate for this key pair at the time of service signup. It is highly advantageous for the disablement confirmation message to be signed by the phone. Otherwise, a fraudulent user in possession of the lost phone could, on intercepting the disablement message, send a false confirmation message, creating a false sense of security for the phone's legitimate owner and stopping all further disablement attempts. The disablement confirmation message can be sent as a secure MIME type Email message from the phone to the RSE-ACS. The disablement confirmation message is not provided for in the WAP push protocol. It is generated by an Email application resident in the phone. The Email contains the disablement status, phone number and transaction ID.

At 510, the RSE-ACS server prepares a response to the user based on the information contained in the Email message from the phone. The RSE-ACS sends either an Email or a voice message to the Email address or telephone call back number left by the user at the time of the service request. At 509, the disablement process ends.

The RSE-ACS will make several attempts over a predetermined period of time to deliver the message, thereby increasing the probability of reaching a phone that is temporarily turned off or otherwise blocked from service. FIG. 6 illustrates message flow where all attempts to reach the phone are exhausted with no confirmation message received. Much of the messaging of FIG. 6 is similar to that of FIG. 5. The user request and verification processes are the same. The initial push message from the Pl to the PPG is shown at 603, and from the PPG to the phone is shown at 604. In this case, the phone is unavailable as shown at 611. After the specified waiting time, 601, the RSE-ACS goes into a retry routine at 602. As long as the maximum number of retries has not been reached under the user's contract with the RSE-ACS service provider, the push messages continue to be retried. Once the contract is fulfilled, the processing leaves the retry loop. A response message that the phone is unavailable is prepared at 612 and the appropriate response is sent to the user.

As an alternative to the above approach, the push message delivery may be attempted only if the phone is known to be logged on to the PLMN. As described previously, this information may or may not be available to the RSE-ACS. If the information is available, its use, as described above, greatly economizes the use of network resources.

The messages and their sequencing for re-enablement according to this embodiment of the invention are essentially the same as for disablement as shown in FIG. 5, except that a forward confirmation message, e.g. “your phone is not enabled”, may be included in the signed object delivered from the RSE-ACS. However, the return confirmation message from the phone does not have to be signed, so that it can be sent as a regular MIME type Email message. The display of the forward confirmation message on the phone itself provides the user with the necessary assurance of proper phone re-enablement. While this display provides the user with immediate confirmation of re-enablement, the return re-enablement confirmation message from the phone to the RSE-ACS provides the latter with proof of service completion. To maintain uniformity with the other services, an Email or voice confirmation of completion of service can be sent by the RSE-ACS to the user-provided Email address or voice call back number. Also, the return confirmation message from the phone would typically not include position information, since position information serves no useful purpose in this case.

An alternative to the push message content type described above would the use of the service loading (SL) message defined in the WAP Push Over-the-Air specification. This message includes the URL of an XML deck on a server where the calling program for the disablement application is located. On receipt of this message and recognition of the SL content type, the phone will fetch the deck from the Internet, thereby triggering the disablement application through a subprogram calling routine such as the WAP External Functional Interface (EFI). While this is a feasible embodiment, it involves an additional round trip of messages, which will consume time. In addition, the receipt of the SL message according to the WAP push message standards will lead to the message being displayed on the phone's screen. Both may be undesirable, because they increase the opportunity for a fraudulent user to become aware that a disablement process in being executed and block it by simply switching off the phone.

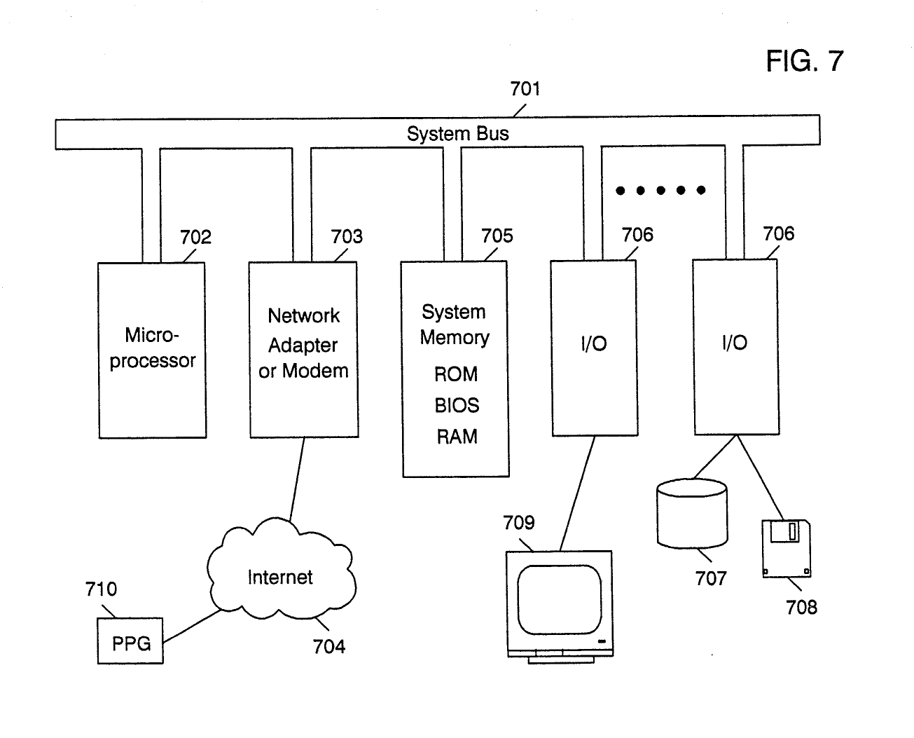

Although the invention operates within the context of networks, some software that can be used to implement the invention resides on and runs on one or more computer systems, which in one embodiment, are personal computers, workstations, or servers, such as might be owned or operated by the RSE-ACS. FIG. 7 illustrates further detail of a computer system that is implementing part of the invention in this way. System bus 701 interconnects the major components. The system is controlled by microprocessor 702, which serves as the central processing unit (CPU) for the system. System memory 705 is typically divided into multiple types of memory or memory areas, such as read-only memory (ROM), random-access memory (RAM) and others. If the computer system is an IBM compatible personal computer, the system memory also contains a basic input/output system (BIOS). A plurality of general input/output (I/O) adapters or devices, 706, are present. Only two are shown for clarity. These connect to various devices including a fixed disk, 707, a diskette drive, 708, and a display, 709. The computer program instructions for implementing the functions of the RSE-ACS are stored on the fixed disk, 707, and are partially loaded into memory 705 and executed by microprocessor 702. The system also includes another I/O device, a network adapter or modem, shown at 703, for connection to the Internet, 704, or to other types of networks which allow the RCE-ACS to communicate with PPG 710. It should be noted that the system as shown in FIG. 7 is meant as an illustrative example only. Numerous types of general-purpose computer systems are available and can be used. Available systems include those that run operating systems such as Windows™ by Microsoft and various versions of UNIX.

Elements of the invention may be embodied in hardware and/or in software (including firmware, resident software, micro-code, etc.). Furthermore, the invention may take the form of a computer program product on a computer-usable or computer-readable storage medium having computer-usable or computer-readable program code embodied in the medium for use by or in connection with an instruction execution system. Such mediums are shown in FIG. 7 to represent the diskette drive, and the hard disk. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Various memory types can be used, for example, to store portions of code at the mobile terminal that relate to the invention. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

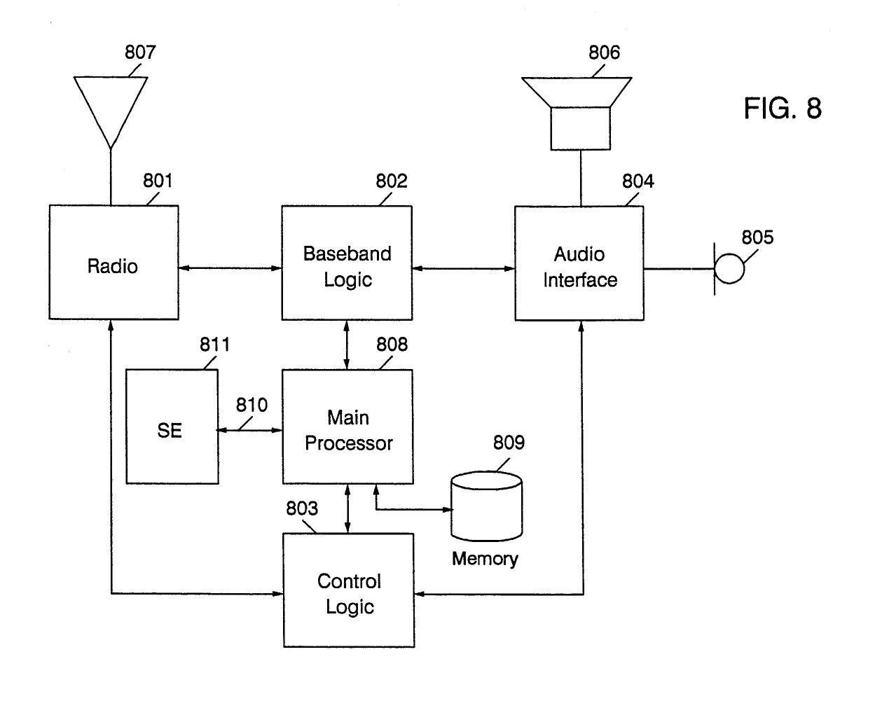

FIG. 8 is a block diagram of a mobile terminal that implements the invention. FIG. 8 illustrates a terminal with voice capability, such as a mobile telephone that includes WAP capability. This illustration is for example only, and the invention works equally well with mobile terminals that are dedicated to communicating with text or other forms of data. As shown in FIG. 8, the terminal includes radio block 801, a baseband logic block, 802, control logic block 803 and an audio interface block, 804. Within radio block 801, the receive and transmit information is converted from and to the radio frequencies (RF) of the various carrier types, and filtering using baseband or intermediate frequency circuitry is applied, as is understood in the art. The terminal's antenna system, 807, is connected to the radio block. In baseband logic block 802, basic signal processing occurs, e.g., synchronization, channel coding, decoding and burst formatting, as is understood in the art. Audio interface block 804 handles voice as well as analog-to-digital (A/D) and D/A processing. It also receives input through microphone 805, and produces output through speaker 806. Control logic block 803, coordinates the aforedescribed blocks and also plays an important role in controlling the human interface components (not shown) such as a key pad and liquid crystal display (LCD). The functions of the aforedescribed transceiving blocks are directed and controlled by one or more microprocessors or digital signal processors such as main processor 808, shown for illustrative purposes. Program code, often in the form of microcode is stored in memory 809 and controls the operation of the terminal through the processor or processors. The processor and memory that controls the overall operation of the terminal are together referred to herein as the “processor system” of the mobile terminal. Some aspects of the invention are implemented in some embodiments by the program code controlling the hardware. In this example, the disablement application is one of these and resides in this memory. The mobile terminal illustrated in FIG. 8 interfaces to the security element, 811, through a smart card reader interface, 810, which, in this example, accepts a SIM, WIM or SWIM card, as previously described. Microcode stored in memory 809 controls the processor 808 to set enabled and disabled states of the registers in the SE. The interconnection between the main processor, control logic, memory, and SE is depicted schematically only for clarity, but is often an internal bus.

While the present invention is described herein in the context of a mobile terminal similar to a traditional “cellular” telephone, as used herein, the terms “mobile terminal”, “wireless terminal”, “wireless communication terminal” and the like are synonymous and may include a cellular radiotelephone with or without a multi-line display; a personal communications system (PCS) terminal that may combine a cellular radiotelephone with data processing, facsimile and data communications capabilities; a personal data assistant (PDA) that can include a radiotelephone, pager, Internet/intranet access, Web browser, organizer; and a conventional laptop and/or palmtop computer or other appliance that includes a radiotelephone transceiver. Mobile terminals are sometimes also referred to as “pervasive computing” devices.

FIG. 8, for clarity, does not show the optional GPS subsystem which the mobile terminal can use to fetch position information. Indeed, the invention can be implemented in a GPS receiver with two-way communication capability and no voice capability. In one embodiment, however, the invention is implemented in a phone like that of FIG. 8 with the addition of a GPS subsystem. GPS is well known to those skilled in the art. GPS is a space-based triangulation system using satellites and computers to measure positions anywhere on the earth. GPS was first developed as a defense system by the United States Department of Defense as a navigational system. Compared to other land-based systems, GPS may be unlimited in its coverage, may provide continuous 24-hour coverage regardless of weather conditions, and is highly accurate. In the current implementation, a constellation of 24 satellites orbiting the earth continually emit a GPS radio frequency signal at a predetermined chip frequency. A GPS receiver receives the radio signals from the closest satellites and measures the time that the radio signals take to travel from the GPS satellites to the GPS receiver antenna. By multiplying the travel time by the speed of light, the GPS receiver can calculate a range for each satellite “in view.” From additional information provided in the radio signal from the satellites, including the satellite's orbit and velocity and correlation to its onboard clock, the GPS processor can calculate the position of the GPS receiver through a process of triangulation. Additional information on GPS can be found in U.S. Pat. No. 6,097,974, which is incorporated herein by reference.

A mobile terminal that implements an embodiment of the invention that includes the optional position information in the confirmation messages, in one embodiment includes a complete GPS subsystem with appropriate switching between the conventional mobile terminal functions and GPS functions managed by the microprocessor or microprocessors. Such a GPS subsystem includes a GPS RF section and GPS antenna and may include dedicated baseband and control logic. It is also possible that many of the GPS and mobile terminal functions share components, such as mixers and oscillators, and even an antenna, depending upon the frequency band in which the mobile terminal operates. In any case, the same microprocessor or microprocessors would normally control both mobile terminal and GPS functions.

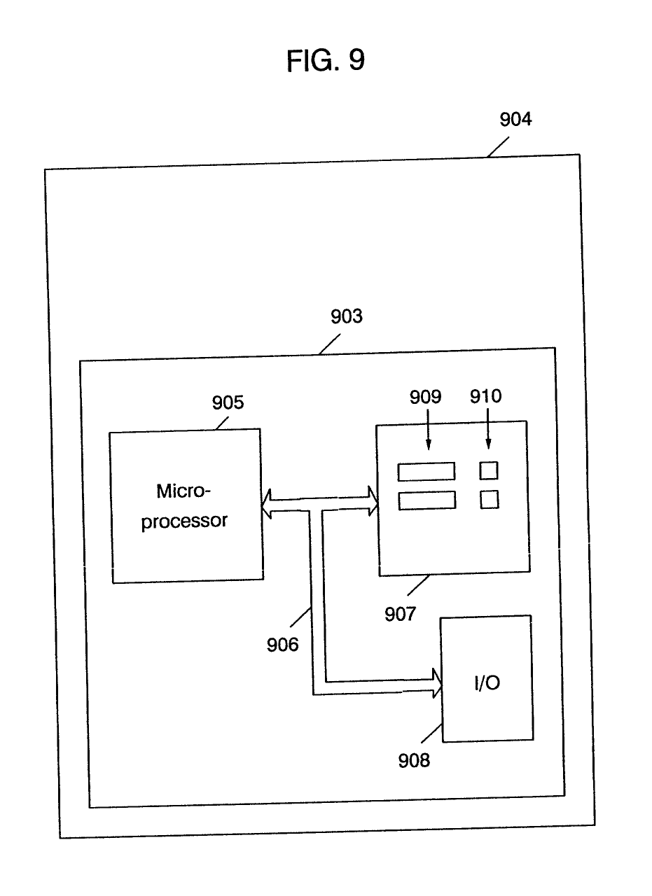

FIG. 9 shows one embodiment of a security element, in this case, implemented as a smart card identity module such as a SIM, WIM or SWIM. The identity module includes a semiconductor chip 903 carried by a support 904. The chip essentially comprises microprocessor 905 connected via a bus 906 with memory 907 and with an I/O interface, 908. The I/O interface includes conventional signaling circuitry coupled to a connector (not shown) with a set of metal contacts designed to come into contact with a complementary connector fitted to the reader shown in FIG. 8.

If the security element of the invention is an identity module as described above, identity data is data is organized in data files. Data in a file is read by the mobile terminal sending over the interface an instruction for selecting the file, and then an instruction for reading within the file. However, the memory in this smart card embodiment of the SE includes a data structure or memory areas including one or more security keys or key pairs, 909, as well as one or more status registers, 910, that serve as status indicators. The status registers are settable by the mobile terminal over an interface like that shown in FIG. 9 to a first state wherein access to the key or key pair is disabled and to a second state wherein access to the key or key pair is enabled. One status indicator in this embodiment is associated with one key or key pair. In the example of FIG. 9, the memory, 907, also includes the keys or key pairs for signature of the return confirmation messages according to the invention, although, for clarity, these are not depicted separately.

We have described herein specific embodiments of an invention. One of ordinary skill in the telecommunications and computing arts will quickly recognize that the invention has other applications in other environments. In fact, many embodiments and implementations are possible. The following claims are in no way intended to limit the scope of the invention to the specific embodiments described above. In addition, the recitation “means for” is intended to evoke a means-plus-function reading of an element in a claim, whereas, any elements that do not specifically use the recitation “means for,” are not intended to be read as means-plus-function elements, even if they otherwise include the word “means.”

We claim:

1. A method of remotely controlling a security element of a mobile terminal for disabling and enabling access to secured functions of the mobile terminal, the method comprising:
receiving a request from a user;
verifying authenticity of the user;
creating a signed push message including, at least, an address for the mobile terminal and content which causes a disablement application to be executed; and
sending the signed push message to the mobile terminal.

2. The method of claim 1 wherein the request and the push message are for disabling access, and further comprising:
receiving a confirmation message from the mobile terminal; and
sending a response message to the user based on the confirmation message.

3. The method of claim 1 wherein the request from the user and the push message are for disabling access, and further comprising:
determining that the mobile terminal is unavailable; and
sending a response message to the user based on a determination that the mobile terminal is unavailable.

4. The method of claim 2 wherein the confirmation message from the mobile terminal is signed.

5. The method of claim 4 wherein the confirmation message and the response include position information for the mobile terminal.

6. The method of claim 1 wherein the request and the push message are for enabling access, and further comprising:
receiving a confirmation message from the mobile terminal; and
sending a response message to the user based on the confirmation message.

7. The method of claim 1 wherein the content comprises an identification of an application that resides in the mobile terminal.

8. The method of claim 1 wherein the content comprises an identification of a calling program residing at a server.

9. The method of claim 2 wherein the content comprises an identification of an application that resides in the mobile terminal.

10. The method of claim 2 wherein the content comprises an identification of a calling program residing at a server.

11. The method of claim 3 wherein the content comprises an identification of an application that resides in the mobile terminal.

12. The method of claim 3 wherein the content comprises an identification of a calling program residing at a server.

13. The method of claim 4 wherein the content comprises an identification of an application that resides in the mobile terminal.

14. The method of claim 4 wherein the content comprises an identification of a calling program residing at a server.

15. The method of claim 5 wherein the content comprises an identification of an application that resides in the mobile terminal.

16. The method of claim 5 wherein the content comprises an identification of a calling program residing at a server.

17. The method of claim 6 wherein the content comprises an identification of an application that resides in the mobile terminal.

18. The method of claim 6 wherein the content comprises an identification of a calling program residing at a server.

19. Apparatus for remotely controlling a security element of a mobile terminal for disabling and enabling access to functions of the mobile terminal, the apparatus comprising:
means for receiving a request from a user;
means for verifying authenticity of the user;
means for creating a signed push message including, at least, an address for the mobile terminal and content which causes a disablement application to be executed;
means for sending the signed push message to the mobile terminal;
means for receiving a confirmation message from the mobile terminal; and
means for sending a response to the user based the confirmation message.

20. A computer program product for enabling a computer system to remotely control a security element of a mobile terminal for disabling and enabling access to secured functions of the mobile terminal, the computer program product including a computer program comprising:
instructions for receiving a request from a user;
instructions for verifying authenticity of the user;
instructions for creating a signed push message including, at least, an address for the mobile terminal and content which causes a disablement application to be executed;
instructions for sending the signed push message to the mobile terminal; and
instructions for sending a response to the user based on an outcome of the sending of the signed push message.

21. The computer program product of claim 20 wherein the content comprises an identification of an application that resides in the mobile terminal.

22. The computer program product of claim 20 wherein the content comprises an identification of a calling program residing at a server.

23. The computer program product of claim 20 further comprising:
instructions for receiving position information for the mobile terminal within a signed confirmation message from the mobile terminal when the request and the signed push message are for disabling access; and
instructions for including the position information for the mobile terminal in the response.

24. The computer program product of claim 21 further comprising:
instructions for receiving position information for the mobile terminal within a signed confirmation message from the mobile terminal when the request and the signed push message are for disabling access; and
instructions for including the position information for the mobile terminal in the response.

25. The computer program product of claim 22 further comprising:
instructions for receiving position information for the mobile terminal within a signed confirmation message from the mobile terminal when the request and the signed push message are for disabling access; and
instructions for including the position information for the mobile terminal in the response.

26. A programmed computer system operable for controlling a security element of a mobile terminal for disabling and enabling access to secured functions of the mobile terminal by performing a method comprising:
receiving a request from a user;
verifying authenticity of the user;
creating a signed push message including, at least, an address for the mobile terminal and content which causes a disablement application to be executed;
sending the signed push message to the mobile terminal; and
sending a response to the user based on an outcome of the sending of the signed push message.

27. The computer system of claim 26 wherein the content comprises an identification of an application that resides in the mobile terminal.

28. The computer system of claim 26 wherein the content comprises an identification of a calling program residing at a server.

29. The computer system of claim 26 further enabled to:
receive position information for the mobile terminal within a signed confirmation message from the mobile terminal when the request and the signed push message are for disabling access; and
include the position information for the mobile terminal in the response.

30. The computer system of claim 27 further enabled to:
receive position information for the mobile terminal within a signed confirmation message from the mobile terminal when the request and the signed push message are for disabling access; and
include the position information for the mobile terminal in the response.

31. The computer system of claim 28 further enabled to:
receive position information for the mobile terminal within a signed confirmation message from the mobile terminal when the request and the signed push message are for disabling access; and
include the position information for the mobile terminal in the response.

32. A system for controlling a security element of a mobile terminal for disabling and enabling access to secured functions of the mobile terminal, the system comprising:
a push initiator operable to create and send signed push messages including, at least, an address for the mobile terminal and content which causes a disablement application to be executed;
a proxy gateway operable to receive the signed push messages and send over-the-air messages to the mobile terminal corresponding to the signed push messages; and
a network interconnecting the push initiator and the proxy gateway.

33. A mobile terminal comprising:
a radio block;
a security element encoded with at least one security key for securing transactions; and
a processor system operably connected to the radio block and the security element, the processor system further operable to disable and enable access to the key in response to unsolicited, over-the-air messages received through the radio block.

34. The mobile terminal of claim 33 wherein the processor system is further operable to disable access to the at least one security key while permitting operations of the security element for which user authentication and authorization services are not required.

35. The mobile terminal of claim 33 wherein the processor system disables access to the at least one security key by disabling access to the security element.

36. The mobile terminal of claim 34 wherein the security element further comprises at least one status register associated with the at least one security key, and wherein the processor system enables and disables access to the key by alternatively setting the status register to a first state wherein access to the at least one security key is enabled and a second state wherein access to the at least one security key is disabled, respectively.

37. The mobile terminal of claim 33 further comprising a global positioning system (GPS) subsystem, and wherein the processor system is further enabled to cause the mobile terminal to send a confirmation message through the radio block, the confirmation message including position information for the mobile terminal, the position information being retrieved from the GPS subsystem.

38. The mobile terminal of claim 34 further comprising a global positioning system (GPS) subsystem, and wherein the processor system is further enabled to cause the mobile terminal to send a confirmation message through the radio block, the confirmation message including position information for the mobile terminal, the position information being retrieved from the GPS subsystem.

39. The mobile terminal of claim 36 further comprising a global positioning system (GPS) subsystem, wherein the processor system is further enabled to cause the mobile terminal to send a confirmation message through the radio block, the confirmation message including position information for the mobile terminal, the position information being retrieved from the GPS subsystem.

40. A security element for a mobile terminal, the security element encoded with a data structure for providing user authentication services, the data structure comprising:
at least one key for securing at least some transactions initiated by a user of the mobile terminal; and
at least one status indicator associated with the at least one key, the status indicator settable by the mobile terminal alternatively to a first state wherein access to the at least one key is enabled and a second state wherein access to the at least one key is disabled.

41. The security element of claim 40 wherein the at least one key is a plurality of key pairs providing user authentication and authorization services through the use of digital signatures, and wherein the at least one status indicator is a plurality of status indicators, further wherein each status indicator is associated with one key pair.

42. In a mobile terminal, a method of controlling access to a security key in a security element, the method comprising:
receiving an unsolicited, over-the-air request to disable access to the security key in the security element;
updating a status register in the security element to disable access to the security key; and
sending an over-the-air, secured confirmation message indicating success of disabling access to the security key.

43. The method of claim 42 further comprising:
receiving an unsolicited, over-the-air request to re-enable access to the security key in the security element; and
updating a status register in the security element to re-enable access to the security key.

44. The method of claim 42 wherein the unsolicited over-the-air, request to disable access takes the form of a wireless application protocol (WAP) push message.

45. The method of claim 43 wherein the unsolicited over-the-air, request to disable access and the unsolicited, over-the-air request to disable access take the form of a wireless application protocol (WAP) push messages.

46. A mobile terminal comprising apparatus for controlling access to at least one security key in a security element, the apparatus comprising:
means for receiving unsolicited, over-the-air requests to disable access to the at least one security key in the security element and to re-enable access to the at least one security key in the security element;
means for updating a status register in the security element in accordance with requests to disable and re-enable access to the at least one security key; and
means for sending over-the-air, secured confirmation messages indicating success of disabling and re-enabling access to the at least one security key.

47. A mobile terminal comprising:
a radio block;
an interface operable to access a security element encoded with at least one security key; and
a processor system operably connected to the radio block and the security element, the processor system further operable to disable and enable access to the key in response to unsolicited, over-the-air messages received through the radio block.

48. The mobile terminal of claim 47 wherein the processor system is further operable to disable access to the at least one security key while permitting operations of the security element for which user authentication and authorization services are not required.

49. The mobile terminal of claim 47 wherein the processor system disables access to the at least one security key by disabling access to the security element.

50. The mobile terminal of claim 47 further comprising a global positioning system (GPS) subsystem, and wherein the processor system is further enabled to cause the mobile terminal to send a confirmation message through the radio block, the confirmation message including position information for the mobile terminal, the position information being retrieved from the GPS subsystem.

51. The mobile terminal of claim 48 further comprising a global positioning system (GPS) subsystem, and wherein the processor system is further enabled to cause the mobile terminal to send a confirmation message through the radio block, the confirmation message including position information for the mobile terminal, the position information being retrieved from the GPS subsystem.
